(19) United States
(12) Patent Application Publication
(10) Pub. No.: US 2010/0054188 A1
(43) Pub. Date: Mar. 4, 2010

(54) Wireless Communication Base Station Apparatus and Wireless Communication Method

(76) Inventors: Atsushi Matsumoto, Ishikawa (JP); Sadaki Futagi, Ishikawa (JP); Daichi Imamura, Kanagawa (JP); Takashi Iwai, Ishikawa (JP); Tomofumi Takata, Ishikawa (JP)

Correspondence Address: Dickinson Wright PLLC;James E. Ledbetter, Esq., International Square, 1875 Eye Street, N.W., Suite 1200, Washington, DC, 20006, US

(21) Appl. No.: 12/531,862

(22) PCT Filed: Mar. 18, 2008
(86) PCT No.: PCT/JP2008/000635

§ 371 Date: Sep. 17, 2009

(30) Foreign Application Priority Data
Mar. 19, 2007 (JP) 2007-071260

(51) Int. Cl. H04W 40/00

(52) U.S. Cl. 370/328

(57) ABSTRACT

A wireless communication base station apparatus capable of suppressing the waste of a signaling source in retransmittal signaling of group scheduling. In this apparatus, a multiplexing part (101) multiplexes ACK or NACK signals to be transmitted to a plurality of terminals belonging to a plurality of groups for initial transmittals, thereby generating ACK/NACK multiplexed signals. A multiplexing part (102) multiplexes the group ID of one retransmittal group associated with the plurality of groups for initial transmittals with control information directed to retransmittal terminals that are some of the plurality of initial transmittal terminals and with the ACK/NACK multiplexed signals generated by the multiplexing part (101), thereby generating a control information multiplexed signal. A mapping part (107) maps the control information multiplexed signal generated by the multiplexing part (102) into PDCCH. A radio transmitting part (110) transmits, via a transmission antenna (111), the control information multiplexed signal mapped in the PDCCH.

### TECHNICAL FIELD

The present invention relates to a radio communication base station apparatus and radio communication method.

### BACKGROUND ART

The 3GPP RAN LTE (Long Term Evolution) is currently studying a method of optimizing L1/L2 control signaling aiming at reduced signaling overhead at the time of scheduling.

Group signaling is proposed as one such method of optimizing L1/L2 control signaling (e.g., see Non-Patent Document 1). FIG. 1 illustrates group signaling. In group signaling, L1/L2 control signals for the initial transmission for a plurality of UE's (User Equipment) are grouped and transmitted as one group. That is, a BS (Base Station) performs signaling by multiplexing, in one transmission time interval (TTI), L1/L2 control signals for a plurality of UE's and the group ID of the group to which the plurality of UE's belong, and transmitting the multiplexed signal using a PDCCH (Physical Downlink Control Channel) for the initial transmission. Here, this PDCCH represents one transmission unit of control signals. That is to say, a PDCCH represents control signals that are transmitted to one group. Furthermore, examples of L1/L2 control signals here include a data demodulation control signal and retransmission control signal, involved in packet communication. The former is a signal for reporting information about the allocation of frequency resources and time resources, the modulation scheme, the coding rate, the data size and so on, and the latter is a signal for reporting retransmission count information, the HARQ process number, redundancy information (redundancy version), buffer erasure information (new data indicator) and so on.

Each UE waits to judge whether or not the group ID of the group to which the UE belongs has been transmitted, and, upon receiving the corresponding group ID, extracts the L1/L2 control signal for the UE from a predetermined location. Through the above-described group signaling, it is possible to reduce the total number of ID's compared to the method of signaling using ID's assigned on a per UE basis, thereby reducing the signaling overhead of the system.

When performing signaling to a retransmitting UE by means of the above-described group signaling, the group ID used upon initial transmission signaling is used as is. As shown in FIG. 1, when UE's, for example UE #1 and UE #4, require a retransmission due to an error upon the initial transmission, L1/L2 control signals for the retransmission are multiplexed in the same fields as the initial transmission in a TTI for a retransmission, and transmitted. On the other hand, L1/L2 control signals for a retransmission need not be transmitted to UE's where the initial transmission succeeded, for example, UE #2 and UE #3, so that the fields for UE #2 and UE #3 in a PDCCH for a retransmission are filled with values such as “0's.” Here, an ACK (positive acknowledgment) or NACK (negative acknowledgment) is signaled to each UE depending on whether or not the field for the UE in the retransmission PDCCH is filled with “0.”

Non-Patent Document 1: 3GPP R2-070055, Ericsson, “Scheduling for maximizing VoIP capacity,” 15th-19th Jan. 2007

### DISCLOSURE OF INVENTION

### Problems to be Solved by the Invention

However, the group signaling of L1/L2 control signals for a retransmission described in Non-Patent Document 1 has a problem of overspending signaling resources. FIG. 2 illustrates how signaling resources are overspent in the group signaling described in Non-Patent Document 1. This figure illustrates a case where signaling is performed by grouping UE #1 to UE #4 into group #A and grouping UE #5 to UE #8 into group #B, and UE #1, UE #4 and UE #5 are retransmitting UE's. As shown in FIG. 2, with group #B subject to a retransmission, the control signal for one UE (UE #5) alone is multiplexed, and the fields for the other three UE's, UE #6 to UE #8, are filled with “0's.” That is, in fields for four UE's, control signals are multiplexed in ¼ of the fields, ¾ of the fields is filled with “0's,” and therefore signaling resources are overspent.

It is therefore an object of the present invention to provide a radio communication base station apparatus and a radio communication method capable of saving signaling resources for retransmission signaling in group signaling.

### Means for Solving the Problem

The radio communication base station apparatus of the present invention adopts a configuration including a first multiplexing section that multiplexes an ACK signal or NACK signal for each of a plurality of terminals belonging to a plurality of groups for the initial transmission to generate an ACK/NACK multiplexed signal, a second multiplexing section that multiplexes the group ID of one retransmission group associated with the plurality of groups and control information for some retransmitting terminals amongst the plurality of terminals, to generate a control information multiplexed signal and a transmitting section that transmits the ACK/NACK multiplexed signal and the control information multiplexed signal.

The radio communication method of the present invention includes the steps of: multiplexing an ACK signal or NACK signal for each of a plurality of terminals belonging to a plurality of groups for the initial transmission to generate an ACK/NACK multiplexed signal; multiplexing a group ID of one retransmission group associated with the plurality of groups and control information for some retransmitting terminals amongst the plurality of terminals to generate a control information multiplexed signal; and transmitting the ACK/NACK multiplexed signal and the control information multiplexed signal.

### Advantageous Effects of Invention

According to the present invention, it is possible to save signaling resources for retransmission signaling in group signaling.

### BRIEF DESCRIPTION OF DRAWINGS

FIG. 1 illustrates conventional group signaling;

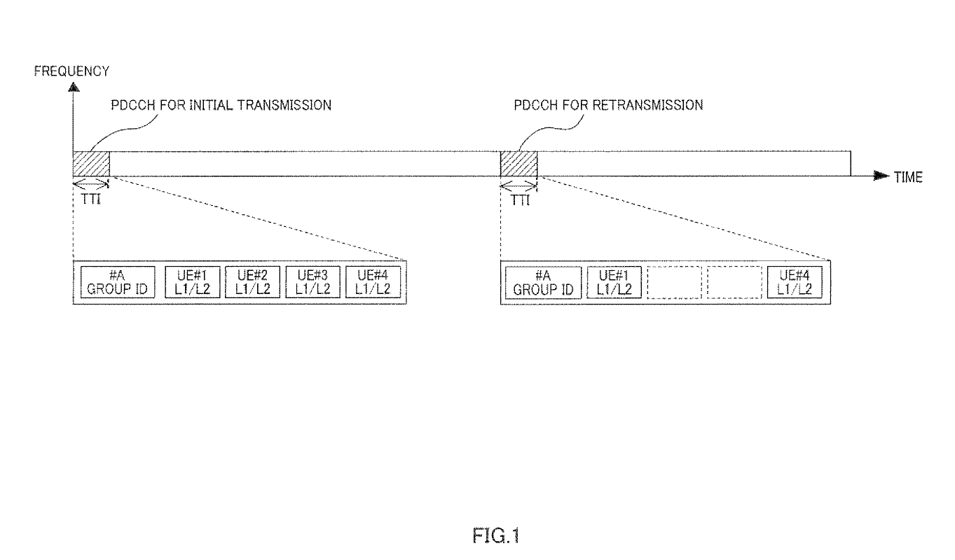

FIG. 2 illustrates how signaling resources are overspent in conventional group signaling;

FIG. 3 is a block diagram showing a configuration of a radio transmitting apparatus according to Embodiment 1 of the present invention;

FIG. 4 shows a control information multiplexed signal that is obtained in the multiplexing section upon initial transmission signaling according to Embodiment 1 of the present invention;

FIG. 5 shows a control information multiplexed signal that is obtained in the multiplexing section upon retransmission signaling according to Embodiment 1 of the present invention;

FIG. 6 shows a result of mapping a control information multiplexed signal that is obtained in the multiplexing section according to Embodiment 1 of the present invention to a PDCCH by the mapping section;

FIG. 7 is a flowchart showing the steps of generating a control information multiplexed signal in the radio transmitting apparatus according to Embodiment 1 of the present invention;

FIG. 8 is a block diagram showing a configuration of the radio receiving apparatus according to Embodiment 1 of the present invention;

FIG. 9 shows an average value of the number of PDCCH's to be required depending on the rate of retransmissions as a theoretical calculation result of the signaling method according to Embodiment 1 of the present invention;

FIG. 10 illustrates a case where the common part of a plurality of group ID's for the initial transmission is used as a group ID of a new group subject to a retransmission according to Embodiment 1 of the present invention;

FIG. 11 illustrates signaling of eight retransmitting UE's using the retransmission signaling method according to Embodiment 1 of the present invention;

FIG. 12 is a block diagram showing a configuration of a radio transmitting apparatus according to Embodiment 2 of the present invention;

FIG. 13 shows a control information multiplexed signal that is obtained in the multiplexing section when the number of retransmitting UE's in retransmission signaling according to Embodiment 2 of the present invention is equal to or above than a predetermined threshold;

FIG. 14 is a flowchart showing the steps of generating a control information multiplexed signal in the radio transmitting apparatus according to Embodiment 2 of the present invention;

FIG. 15 is a block diagram showing a configuration of a radio receiving apparatus according to Embodiment 2 of the present invention;

FIG. 16 shows an average value of the number of PDCCH's to be required depending on the rate of retransmissions as a theoretical calculation result using the signaling method according to Embodiment 2 of the present invention;

FIG. 17 is a block diagram showing a configuration of a radio transmitting apparatus according to Embodiment 3 of the present invention;

FIG. 18 shows a control information multiplexed signal that is obtained in the multiplexing section upon retransmission signaling according to Embodiment 3 of the present invention;

FIG. 19 shows a result of mapping a control information multiplexed signal that is obtained in the multiplexing section according to Embodiment 3 of the present invention to a PDCCH by the mapping section;

FIG. 20 is a block diagram showing a configuration of the radio receiving apparatus according to Embodiment 3 of the present invention;

FIG. 21 shows an average value of the number of PDCCH's to be required depending on the rate of retransmissions as a theoretical calculation result using the signaling method according to Embodiment 3 of the present invention; and

FIG. 22 shows another form for identifying retransmitting UE's in retransmission signaling according to the present invention.

### BEST MODE FOR CARRYING OUT THE INVENTION

Hereinafter, embodiments of the present invention will be explained in detail with reference to the accompanying drawings. The following explanations assume a radio communication base station apparatus as a radio transmitting apparatus and eight UE's as radio receiving apparatuses. The following explanations also assume a case where group signaling is performed on L1/L2 control signals through a downlink PDCCH to perform scheduling of uplink packet transmission. Four UE's are grouped as one group, and upon initial transmission signaling, for example, UE #1 to UE #4 are grouped as group #A, and UE #5 to UE #8 are grouped as group #B. Furthermore, the size of an L1/L2 control signal for each UE is the same between the initial transmission and retransmissions.

### Embodiment 1

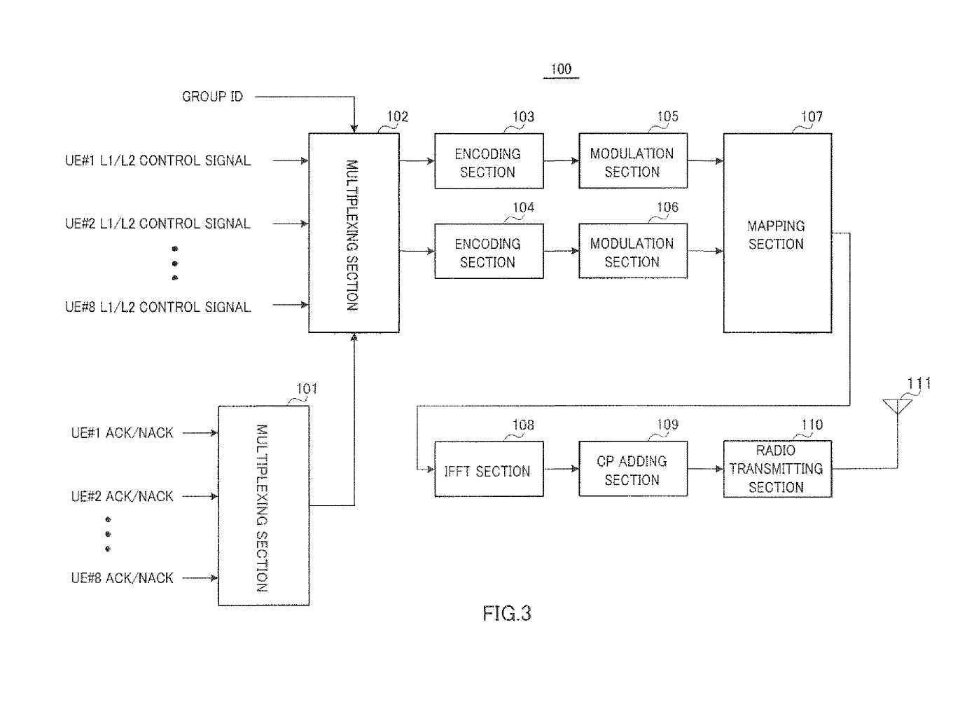

FIG. 3 is a block diagram showing a configuration of radio transmitting apparatus 100 according to Embodiment 1 of the present invention.

Multiplexing section 101 groups ACK/NACK signals for UE's belonging to a plurality of predetermined groups to generate an ACK/NACK multiplexed signal only upon retransmission signaling. To be more specific, multiplexing section 101 multiplexes ACK/NACK signals for eight UE's, UE #1 to UE #4 belonging to group #A and UE #5 to UE #8 belonging to group #B, and outputs an ACK/NACK multiplexed signal obtained, to multiplexing section 102.

Upon initial transmission signaling, multiplexing section 102 multiplexes the initial transmission group IDs and L1/L2 control signals for a plurality of UE's subject to the initial transmission, on a per group basis, and, upon retransmission signaling, multiplexes retransmission group IDs, L1/L2 control signals for a plurality of retransmitting UE's, and the ACK/NACK multiplexed signal received as input from multiplexing section 101, on a per retransmission group basis, to generate a control information multiplexed signal. Multiplexing section 102 outputs the control information multiplexed signal, obtained per group, to encoding section 103 and encoding section 104. For example, when performing initial transmission signaling, multiplexing section 102 outputs the control information multiplexed signal corresponding to group #A to encoding section 103 and outputs the control information multiplexed signal corresponding to group #B to encoding section 104.

Encoding sections 103 and 104 perform error correcting encoding such as convolutional encoding and turbo encoding to the control information multiplexed signals received as input from multiplexing section 102, and output the error correcting encoded signals obtained, to modulation sections 105 and 106.

Modulation sections 105 and 106 perform, modulation processing such as PSK modulation (Phase Shift Keying) and QAM modulation (Quadrature Amplitude Modulation) to the error correcting encoded signals received as input from encoding sections 103 and 104, and output the modulated signals obtained, to mapping section 107.

Mapping section 107 maps the modulated signals received as input from modulation sections 105 and 106 to the respective PDCCH's in the same TTI.

IFFT (Inverse Fast Fourier Transform) section 108 performs IFFT processing on the signals mapped to the PDCCH's, and outputs the time domain signal obtained, to CP (Cyclic Prefix) adding section 109.

CP adding section 109 adds the rear end portion of the time domain signal received as input from IFFT section 108 to the head of that time domain signal, and outputs the signal with a CP obtained, to radio transmitting section 110.

Radio transmitting section 110 performs radio transmission processing such as D/A conversion, amplification and up-conversion on the signal with a CP received as input from CP adding section 109, and transmits the signal via transmitting antenna 111.

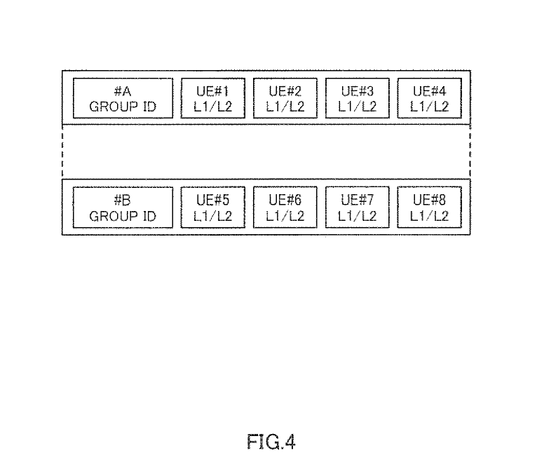

FIG. 4 shows a control information multiplexed signal that is obtained in multiplexing section 102 upon initial transmission signaling.

Since radio transmitting apparatus 100 need not transmit ACK/NACK signal in initial transmission signaling, multiplexing section 101 does not generate an ACK/NACK multiplexed signal. As shown in FIG. 4, multiplexing section 102 arranges the group IDs and L1/L2 control signals for four UE's belonging to the group, in predetermined locations in the control information multiplexed signal. Multiplexing section 102 performs this operation the same number of times as the number of groups. For example, multiplexing section 102 multiplexes the group ID “#A” and L1/L2 control signals for UE #1 to #4, to generate a control information multiplexed signal corresponding to group #A, and multiplexes the group ID “#B” and L1/L2 control signals for UE #5 to #8, to generate a control information multiplexed signal corresponding to group #B. Here, the L1/L2 control signal for each UE is multiplexed in a predetermined location.

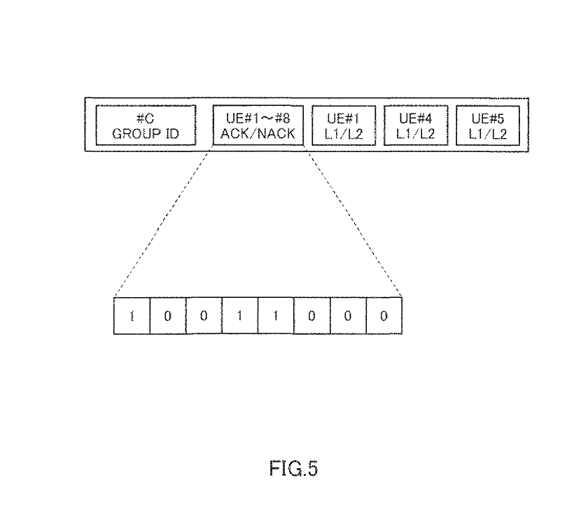

FIG. 5 shows a control information multiplexed signal that is obtained in multiplexing section 102 upon retransmission signaling. FIG. 5 illustrates a case where three UE's of UE #1, UE #4 and UE #5 are retransmitting UE's.

Upon retransmission signaling, multiplexing section 101 multiplexes ACK/NACK signals for eight UE's to generate an ACK/NACK multiplexed signal. To be more specific, ACK/NACK signals for eight UE's are represented, using, respectively, the eight bits making up the ACK/NACK multiplexed signal. As shown in FIG. 5, when UE #1, UE #4 and UE #5 are retransmitting UE's, multiplexing section 101 generates an ACK/NACK multiplexed signal of “10011000,” Here, each “1” bit is a NACK and each “0” bit is an “ACK.” Therefore, in this example, since the values of the first, fourth and fifth bits in the ACK/NACK multiplexed signal are “1,” the index numbers of the retransmitting UE's are #1, #4 and #5, in order. Each UE can detect the index number of a UE subject to a retransmission using the ACK/NACK multiplexed signal in this configuration and can further identify in which location the L1/L2 control signal for each UE is multiplexed in the control information multiplexed signal, which is comprised of the group ID, ACK/NACK multiplexed signal and L1/L2 control signals for the retransmitting UE's. Multiplexing section 101 outputs the ACK/NACK multiplexed signal generated to multiplexing section 102.

Upon retransmission signaling, multiplexing section 102 groups the L1/L2 control signals for the three retransmitting UE's of UE #1, UE #4 and UE #5, as group #C. To be more specific, multiplexing section 102 arranges the group ID of group #C at the beginning of the control information multiplexed signal as shown in FIG. 5, and, following this, arranges the ACK/NACK multiplexed signal received as input from multiplexing section 101 and the L1/L2 control signals for UE #1, UE #4 and UE #5, in order. Here, since the group ID of group #C is associated with group #A and group #B, it is possible to reduce signaling overhead for reporting the group ID of group #C separately. Furthermore, the index numbers of the bits assuming the value “1” in the ACK/NACK multiplexed signal received as input from multiplexing section 101 indicate the numbers of the respective retransmitting UE's corresponding to the respective L1/L2 control signals arranged behind the ACK/NACK multiplexed signal in the control information multiplexed signal. In this example, since the values of the first, fourth and fifth bits in the ACK/NACK multiplexed signal are “1,” the L1/L2 control signals arranged behind the ACK/NACK multiplexed signal correspond to UE #1, UE #4 and UE #5, in order. The locations of the group ID, ACK/NACK multiplexed signal and L1/L2 control signals for respective UE's in the control information multiplexed signal are not limited to the above-described locations, and any locations may be adopted if information about the locations is shared between the base station and UE's in advance.

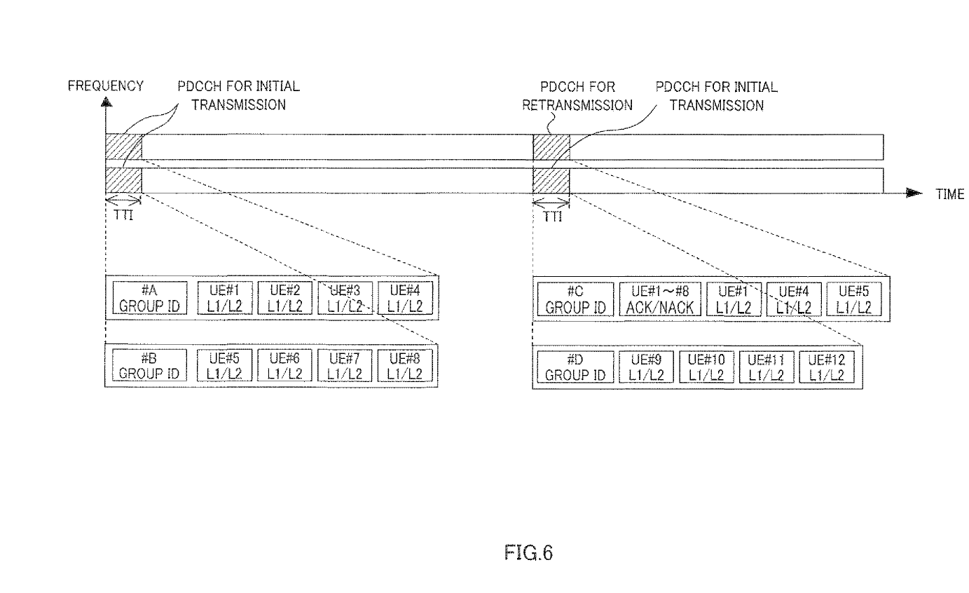

FIG. 6 shows a result of mapping the control information multiplexed signal that is obtained in multiplexing section 102 to a PDCCH by mapping section 107.

As shown in FIG. 6, upon retransmission signaling, multiplexing section 102 is able to save signaling resources by grouping L1/L2 control signals for UE #1, UE #4 and UE #5, which are retransmitting UE's, as group #C, Furthermore, by grouping L1/L2 control signals for initial transmitting UE's, for example, UE #9 to #12, as group #D, and transmitting the grouped L1/L2 control signals in the same TTI as group #C, multiplexing section 102 is able to improve the number of users for which control signals can be transmitted per unit time.

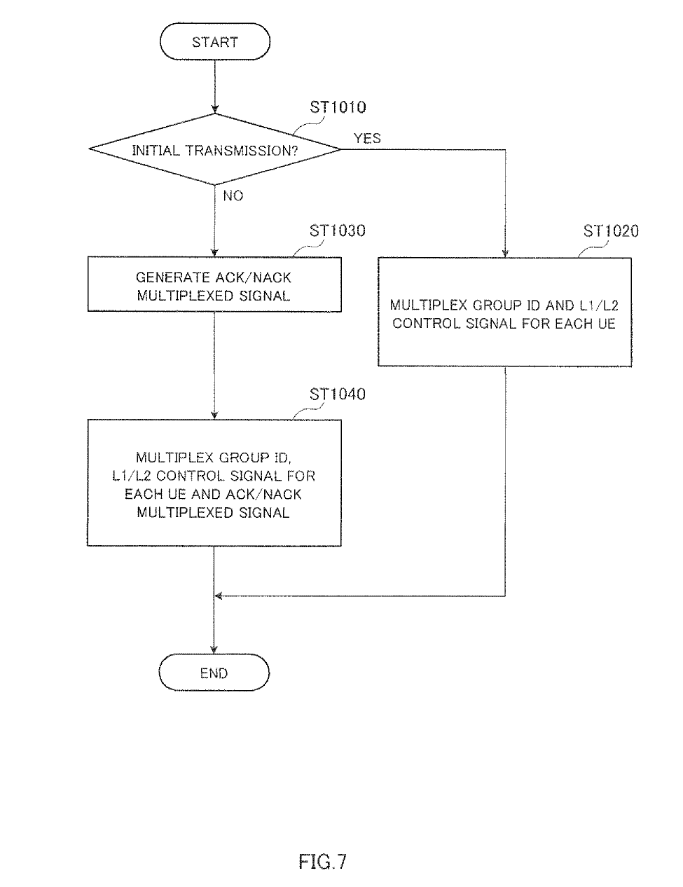

FIG. 7 is a flowchart showing the steps of generating a control information multiplexed signal in radio transmitting apparatus 100 according to the present embodiment.

First, in step (hereinafter “ST”) 1010, radio transmitting apparatus 100 determines whether signaling processing is the initial transmission signaling or retransmission signaling.

When it is determined in ST 1010 that the signaling processing is initial transmission signaling (ST 1010: “YES”), multiplexing section 102 multiplexes the group ID and L1/L2 control signals for the respective UE's to generate a control information multiplexed signal in ST 1020.

On the other hand, when it is determined in ST 1010 that the signaling processing is retransmission signaling (ST 1010: “NO”), multiplexing section 101 multiplexes ACK/NACK signals of retransmitting UE's to generate an ACK/NACK multiplexed signal in ST 1030.

Next, in ST 1040, multiplexing section 102 multiplexes the group ID, L1/L2 control signals for the respective UE's and ACK/NACK multiplexed signal generated in multiplexing section 101 to generate a control information multiplexed signal.

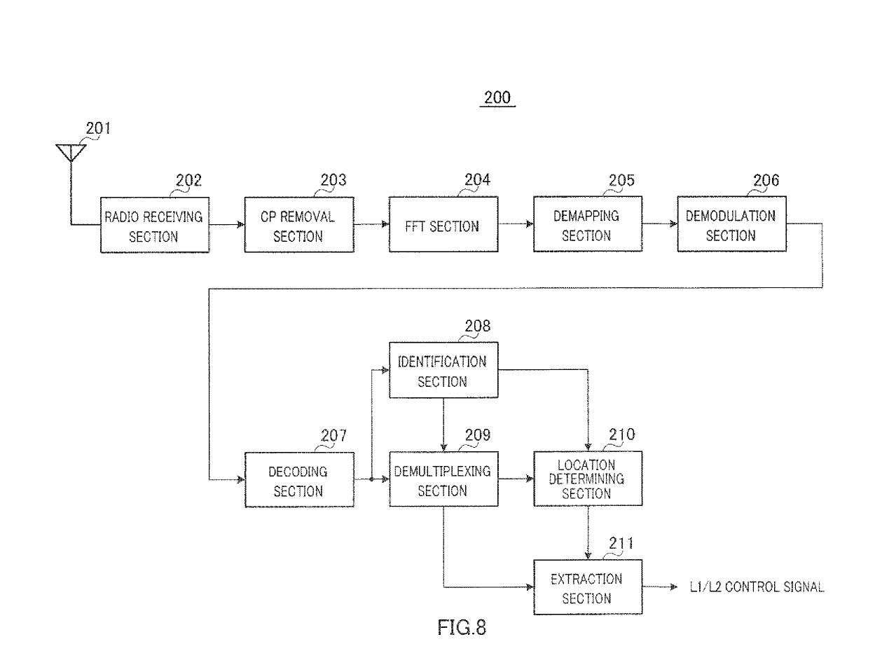

FIG. 8 is a block diagram showing a configuration of radio receiving apparatus 200 according to the present embodiment.

Radio receiving section 202 receives a radio signal transmitted from radio transmitting apparatus 100 via receiving antenna 201, performs radio reception processing such as down-conversion, A/D conversion and outputs the digital signal obtained to CP removal section 203.

CP removal section 203 removes the CP added to the beginning of the digital signal received as input from radio receiving section 202 and outputs the signal without a CP obtained, to FFT (Fast Fourier Transform) section 204.

FFT section 204 performs FFT processing on the Signal without a CP obtained, received as input from CP removal section 203 and outputs the frequency domain signal obtained to demapping section 205.

Demapping section 205 separates the frequency domain signal received as input from FFT section 204 on a per PDCCH basis and outputs each PDCCH signal obtained to demodulation section 206.

Demodulation section 206 performs demodulation processing on each PDCCH signal received as input from demapping section 205 and outputs the demodulated signal obtained to decoding section 207.

Decoding section 207 performs error correction such as convolutional decoding and turbo decoding on the demodulated signal received as input from demodulation section 206 and outputs the decoded signal obtained to identification section 208 and demultiplexing section 209.

Identification section 208 identifies whether or not the group ID arranged at the beginning of the decoded signal received as input from decoding section 207, is the group ID of the group to which the subject UE belongs, and, further identifies, when the group ID is the group ID of the group to which the subject UE belongs, whether the decoded signal received as input from decoding section 207 is for the initial transmission or for a retransmission, and outputs the identification result to demultiplexing section 209 and location determining section 210.

Demultiplexing section 209 demultiplexes the group ID from the decoded signal received as input from decoding section 207. Furthermore, demultiplexing section 209 demultiplexes, when the identification result received as input from identification section 208 indicates that the decoded signal is for a retransmission, the ACK/NACK multiplexed signal from the decoded signal, outputs the ACK/NACK multiplexed signal obtained to location determining section 210, and outputs the L1/L2 control signals for a plurality of UE's, to extraction section 211.

When the identification result received as input from identification section 208 indicates that the decoded signal is for the initial transmission, location determining section 210 does not receive an ACK/NACK multiplexed signal as input from demultiplexing section 209, and outputs the predetermined location where the L1/L2 control signal for the subject UE is arranged, to extraction section 211. Furthermore, when the identification result received as input from identification section 208 indicates that the decoded signal is for a retransmission, location determining section 210 determines the location where the L1/L2 control signal for the subject UE is arranged, amongst the L1/L2 control signals for the plurality of UE's, based on the values of the bits in the ACK/NACK multiplexed signal received as input from demultiplexing section 209, and outputs the location determination result to extraction section 211.

Based on the location determination result received as input from location determining section 230, extraction section 211 extracts the L1/L2 control signal for the subject UE, amongst the L1/L2 control signals for the plurality of UE's received as input from demultiplexing section 209.

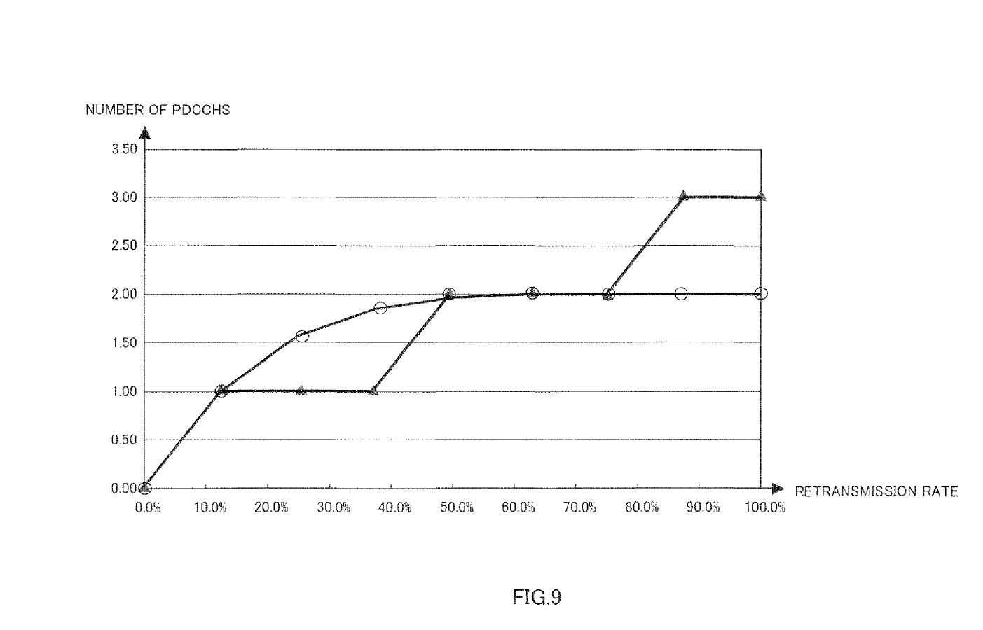

FIG. 9 shows an average value of the number of PDCCH's to be required depending on the rate of retransmissions, as a theoretical calculation result of the signaling method according to the present embodiment. For comparison, FIG. 9 also shows an average value of the number of PDCCH's to be required depending on the rate of retransmissions as a theoretical calculation result of the signaling method according to Non-Patent Document 1 at the same time. FIG. 9 shows the average value of the number of PDCCH's according to the present embodiment using the graph shown by the symbol “▴” and shows the average value of the number of PDCCH's according to Non-Patent Document 1 using the graph shown by the symbol “∘.” Here, the “retransmission rate” refers to the probability that a retransmission is required due to a reception error when a transmission signal is transmitted.

As shown in FIG. 9, at a retransmission rate of approximately 75% or below, the average value of the number of PDCCCH's according to the present embodiment is lower than the average value of the number of PDCCH's according to Non-Patent Document 1. This is because with the signaling method according to Non-Patent Document 1, the same number of PDCCH's as the number of groups are necessary when a retransmission occurs in even one UE in each of a plurality of different groups. On the other hand, as shown in FIG. 9, at a retransmission rate higher than 75%, approximately, the average value of the number of PDCCCH's according to the present embodiment is higher than the average value of the number of PDCCH's according to Non-Patent Document 1. However, the rate of retransmissions of a system that performs AMC (Adaptive Modulation and Coding) is normally set between 10% and 30%, and the system is never operated using retransmission rates of 75% or above. That is, the signaling method according to the present embodiment can save signaling resources more than the signaling method according to Non-Patent Document 1.

As described so far, according to the present embodiment, the radio transmitting apparatus multiplexes ACK signals or NACK signals for a plurality of UE's belonging to a plurality of groups for the initial transmission to generate an ACK/NACK multiplexed signal, and multiplexes the group ID of one retransmission group associated with a plurality of groups for the initial transmission, L1/L2 control signals for retransmitting UE's and an ACK/NACK multiplexed signal, and transmits the multiplexed signal. Therefore, it is possible to reduce the number of PDCCH's used for retransmission signaling, use the saved PDCCH's for initial transmission signaling for new UE's, and improve the number of users for which control signals can be transmitted per unit time.

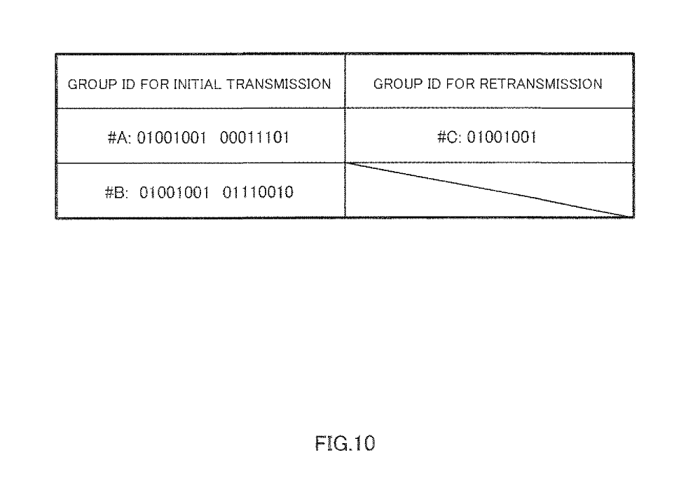

Furthermore, a case has been explained above with the present embodiment as an example where signaling is performed by grouping a plurality of retransmitting UE's into a group having a new group ID that is different from the initial transmission group ID's. However, the present invention is not limited to this, and it is equally possible to use the common part of a plurality of group ID's for the initial transmission as the group ID for a new retransmission group, as shown in FIG. 10. FIG. 10 shows a case where “0100100100011101” and “0100100101110010” are used as the group ID's for initial transmission groups #A and #B and “01001001” is used as the group ID for retransmission group #C. Here, the group ID “01001001” for retransmission group #C is comprised of the initial eight bits of the group ID's “0100100100011101” and “0100100101110010” for initial transmission groups #A and #B. A UE that belonged to group #A or group #B upon initial transmission signaling can determine, when retransmission group #C is received, whether or not the signal is a retransmission control signal for that UE, from the correlations between the group ID of group #C and the group ID's of groups #A and #B. As shown in FIG, 10, if the common part of the group ID's of groups #A and #B is used as the group ID of group #C, only eight bits are used as the group ID of group #C and eight bits can be saved compared to a normal group ID.

Furthermore, by multiplexing ACK/NACK signals in the same PDCCH with the group ID and L1/L2 control signals for individual UE's, the length of the processing information bit sequence for error correction increases, and therefore the error correction performance improves compared to a case where an ACK/NACK signal is transmitted as a single PDCCH.

As described so far, present Embodiment 1 performs signaling by grouping a plurality of UE's that belong to a plurality of different groups upon initial transmission signaling, into the same group upon retransmission signaling. Here, when a UE receives retransmission signaling, a plurality of group ID's for the initial transmission are associated with the retransmission group ID in advance, so that the UE can identify the retransmission group to which the UE belongs. Furthermore, when a UE receives a control information multiplexed signal for a retransmission, the UE needs to report in which location in the control information multiplexed signal the control signal for that UE is multiplexed. As one means of this reporting method, an ACK/NACK signal is used. To be more specific, by adopting a configuration whereby an ACK/NACK signal is made decodable between a plurality of UE's and by determining the ACK/NACK bit location for the subject UE in advance, it is possible to determine the location where the control signal for the subject UE is multiplexed, from the bit pattern of the ACK/NACK multiplexed signal that is received. The method of reporting the multiplexing location in the control signal for the subject UE is not limited to ACK/NACK signals, and, for example, dedicated report signals may be used. Furthermore, according to Embodiment 1, the group ID, ACK/NACKs for UEs and control signal for UEs are connected to provide an information signal (referred to as “multiplexing” in the above embodiment), and this information signal is then subjected to encoding processing and modulation processing as a single encoding block, and then mapped to radio resources and transmitted. Furthermore, as described above, the signaling format differs between the initial transmission and retransmissions, so that by differentiating the group ID's between the initial transmission and retransmissions, UEs can specify the signaling format of a received signal by only identifying the group ID. When the transmission timing upon a retransmission is known, it is possible to reduce the number of ID's by making the initial transmission group ID's and retransmission group ID's the same.

### Embodiment 2

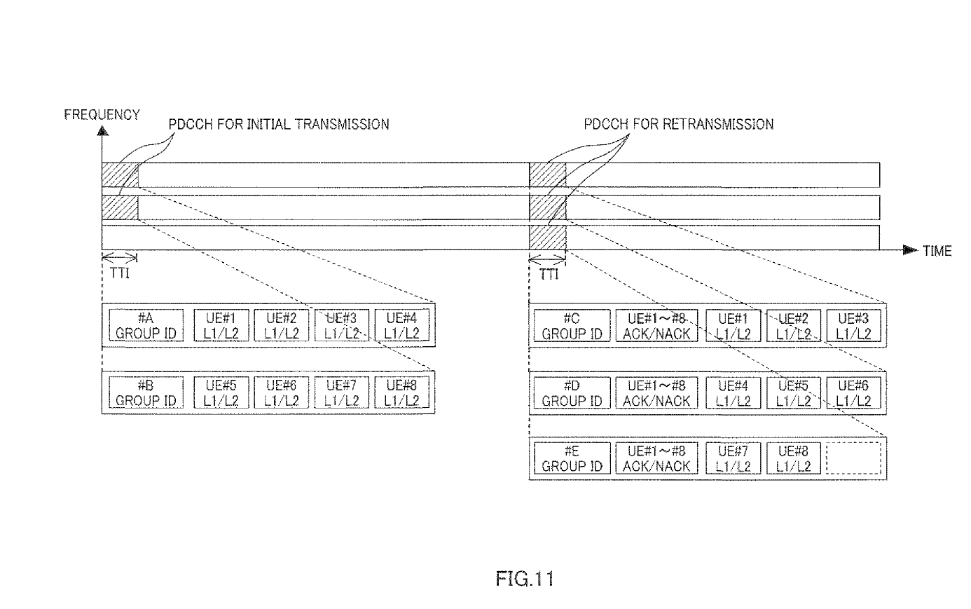

FIG. 11 illustrates a case where signaling is performed for eight retransmitting UE's using the retransmission signaling method according to Embodiment 1 of the present invention.

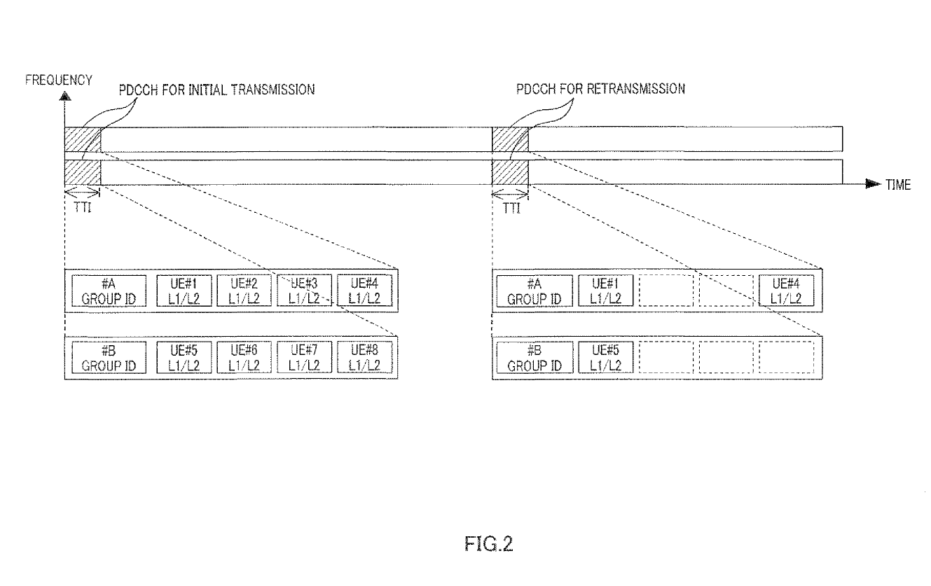

As shown in FIG. 11, when signaling is performed for eight retransmitting UE's using the retransmission signaling method of Embodiment 1 of the present invention, transmission needs to be performed by grouping the eight UE's into three groups and using three PDCCH's. As is clear from a comparison between FIG. 2 and FIG. 11, when signaling is performed for a predetermined number or greater number of retransmitting UE's using the retransmission signaling method according to Embodiment 1 of the present invention, the number of PDCCH's required may exceed that of the signal retransmission method according to Non-Patent Document 1. This is because a control information multiplexed signal for a retransmission further includes an ACK/NACK multiplexed signal compared to a control information multiplexed signal for the initial transmission, and therefore the field for transmitting L1/L2 control signals for retransmitting UE's is decreased by an amount corresponding to the field of the ACK/NACK multiplexed signal.

Embodiment 2 of the present invention changes the retransmission signaling method depending on whether or not the number of retransmitting UE's is equal to or greater than a predetermined threshold, and thereby saves signaling resources.

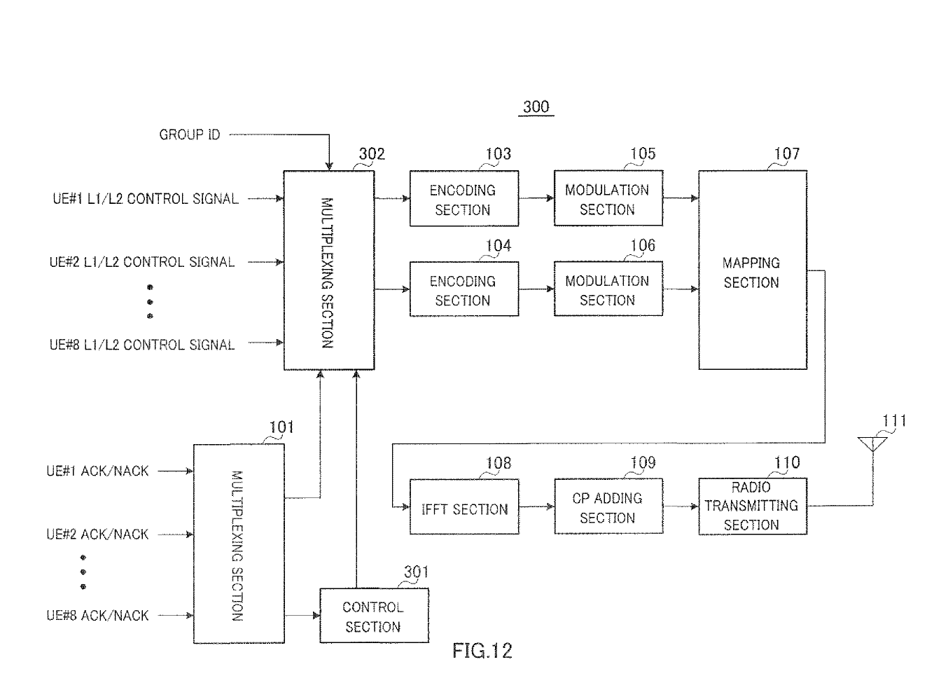

FIG. 12 is a block diagram showing a configuration of radio transmitting apparatus 300 according to Embodiment 2 of the present invention. Radio transmitting apparatus 300 has the same basic configuration as radio transmitting apparatus 100 (see FIG. 3) shown in Embodiment 1, and the same components will be assigned the same reference numerals and explanations thereof will be omitted.

Radio transmitting apparatus 300 differs from radio transmitting apparatus 100 in that control section 301 is further provided. The processing in multiplexing section 302 of radio transmitting apparatus 300 differs in part from the processing in multiplexing section 102 of radio transmitting apparatus 100, and is assigned different reference numerals to show the differences.

Control section 301 controls the multiplexing processing method of multiplexing section 302 based on the number of bits of an ACK/NACK multiplexed signal received as input from multiplexing section 101 whose value is “1,” that is, based on the number of retransmitting UE's, and thereby changes the retransmission signaling method of radio transmitting apparatus 300.

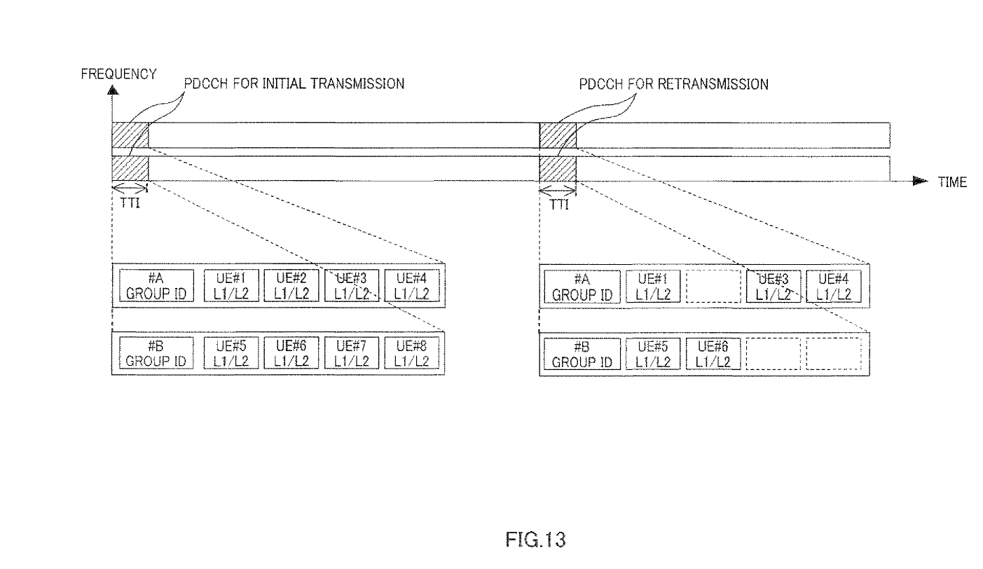

Based on the control by control section 301, multiplexing section 302 changes the multiplexing processing method depending on cases, including the case of initial transmission signaling, the case of retransmission signaling where the number of retransmitting UE's is smaller than a predetermined threshold, and the case of retransmission signaling where the number of retransmitting UE's is equal to or greater than the predetermined threshold. To be more specific, upon initial transmission signaling and upon retransmission signaling where the number of retransmitting UE's is smaller than the predetermined threshold, multiplexing section 302 performs the same processing as the processing in multiplexing section 102 of radio transmitting apparatus 100 upon initial transmission signaling and multiplexing processing upon retransmission signaling (see FIG. 4 to FIG. 6), to generate a control information multiplexed signal. Furthermore, upon retransmission signaling where the number of retransmitting UE's is equal to or greater than the predetermined threshold, multiplexing section 302 generates a control information multiplexed signal as shown in FIG. 13, which will be described later. Here, “4” is used as the predetermined threshold.

FIG. 13 shows the control information multiplexed signal that is obtained in multiplexing section 302 when the number of retransmitting UE's is equal to or greater than the predetermined threshold in retransmission signaling.

FIG. 13 illustrates a case where the number of retransmitting UE's is equal to the threshold, that is, “4.” As shown in FIG. 13, multiplexing section 302 multiplexes a group ID and L1/L2 control signals for the respective retransmitting UE's using the retransmission signaling method according to Non-Patent Document 1 (see FIG. 2).

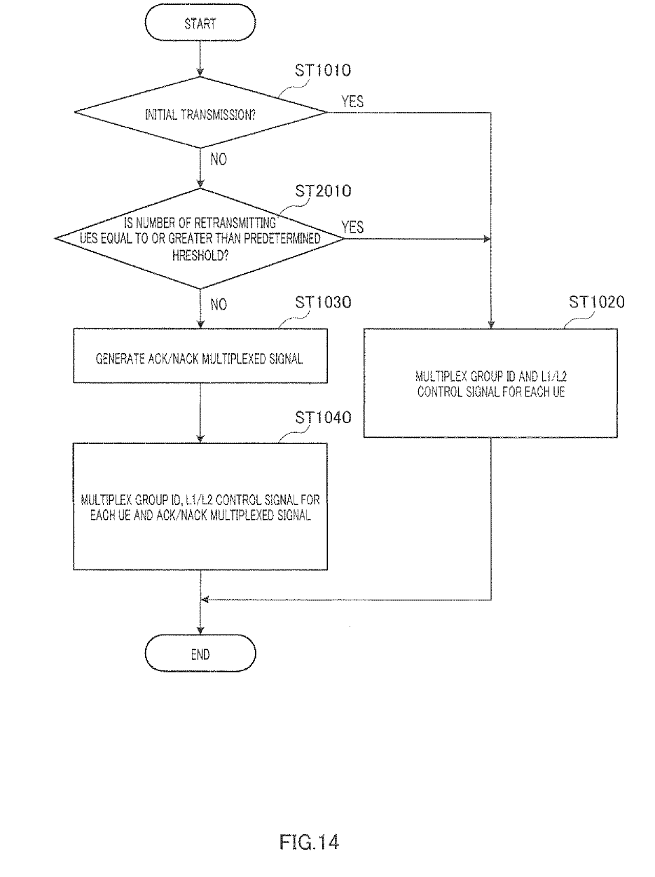

FIG. 14 is a flowchart showing the steps of generating a control information multiplexed signal in radio transmitting apparatus 300 according to the present embodiment.

The steps of generating a control information multiplexed signal in radio transmitting apparatus 300 according to the present embodiment follows the same basic steps as in the steps of generating a control information multiplexed signal in radio transmitting apparatus 100 according to Embodiment 1 (see FIG. 7) and the same steps will be assigned the same reference numerals and explanations thereof will be omitted. The steps shown in FIG. 14 are different from the steps shown in FIG. 7 in that ST 2010 is further included.

In ST 2010, control section 301 determines whether or not the number of retransmitting UE's is equal to or greater than a predetermined threshold. When it is determined in ST 2010 that the number of retransmitting UE's is equal to or greater than the predetermined threshold (ST 2010: “YES”), the step moves onto ST 1020, whereas, when it is determined that the number of retransmitting UE's is smaller than the predetermined threshold (ST 2010: “NO”), the step moves onto ST 1030.

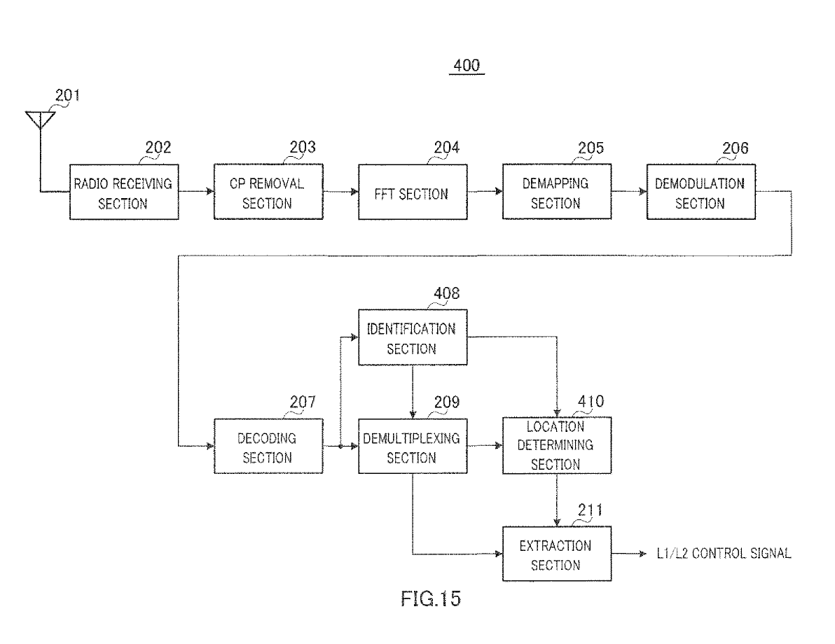

FIG. 15 is a block diagram showing a configuration of radio receiving apparatus 400 according to the present embodiment.

Radio receiving apparatus 400 has the same basic configuration as radio receiving apparatus 200 shown in Embodiment 1 (see FIG. 8), and the same components will be assigned the same reference numerals and explanations thereof will be omitted. Identification section 408 and location determining section 410 of radio receiving apparatus 400 execute processing partially different from that of identification section 208 and location determining section 210 of radio transmitting apparatus 200, and are therefore assigned different reference numerals to show the differences.

Identification section 408 identifies whether or not the group ID arranged at the beginning of the decoded signal received as input from decoding section 207 is the group ID of the group to which the subject UE belongs or whether the decoded signal is for the initial transmission or for a retransmission, and further identifies the signaling format. The more detailed method, of identifying the signaling format is to identify that the decoded signal includes ACK/NAK when the group ID is a retransmission group ID and identify that the decoded signal includes no ACK/NACK when the group ID is a group ID other than the group ID for a retransmission and outputs the identification result to demultiplexing section 209 and location determining section 410.

When the identification result received as input from identification section 408 indicates that the decoded signal is for the initial transmission or when the identification result received as input from identification section 408 indicates the same retransmission signaling format as the initial transmission signaling format (i.e. when the number of retransmitting UE's is equal to or greater than a predetermined threshold), location determining section 410 does not receive an ACK/NACK multiplexed signal as input from demultiplexing section 209, and outputs the predetermined location where the L1/L2 control signal for the subject UE is arranged, to extraction section 211. On the other hand, when the identification information received as input from identification section 408 indicates a signaling format that is dedicated to a retransmission and that is different from the initial transmission signaling format (i.e. when the number of retransmitting UE's is smaller than a predetermined threshold), location determining section 410 determines the location where the L1/L2 control signal for the subject UE is arranged, amongst the L1/L2 control signals for the plurality of UE's, based on the values of the bits in the ACK/NACK multiplexed signal received as input from demultiplexing section 209, and outputs the location determination result obtained to extraction section 211.

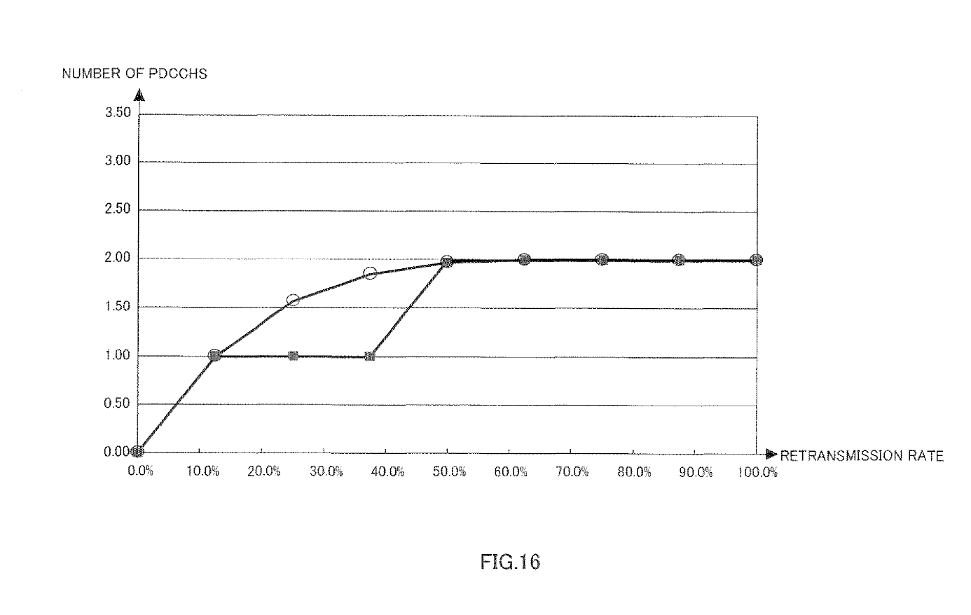

FIG. 16 shows an average value of the number of PDCCH's to be required depending on the rate of retransmissions as a theoretical calculation result of the signaling method according to the present embodiment.

For comparison, FIG. 16 also shows an average value of the number of PDCCH's to be required depending on the rate of retransmissions as a theoretical calculation result of the signaling method according to Non-Patent Document 1 at the same time. FIG. 16 shows the average value of the number of PDCCH's according to the present embodiment using the graph shown by the symbol “▪” and shows the average value of the number of PDCCH's according to Non-Patent Document 1 using the graph shown by the symbol “∘.” Here, the “retransmission rate” refers to the probability that a retransmission is required due to a reception error when a transmission signal is transmitted.

As shown in FIG. 16, an average value of the number of PDCCH's according to the present embodiment is always equal to or less than the average value of the number of PDCCH's according to Non-Patent Document 1. Furthermore, as is clear from a comparison between FIG. 9 and FIG. 16, the average value of the number of PDCCH's according to the present embodiment is equal to or less than the average value of the number of PDCCH's according to Embodiment 1 even at retransmission rates equal to or greater than 75%.

Thus, as described above, according to the present embodiment, the radio transmitting apparatus determines whether or not the number of retransmitting UE's is equal to or greater than a predetermined threshold and changes the retransmission signaling method based on the determination result, thereby further improving the number of users for which control signals can be transmitted per unit time.

A case has been explained above with the present embodiment where a predetermined threshold is assumed to be “4” but the value of the predetermined threshold is depends upon the number of UE's accommodated per group and therefore is not limited to “4.” For example, when the number of UE's that can be accommodated per group is “5,” “5” is set as the predetermined threshold.

### Embodiment 3

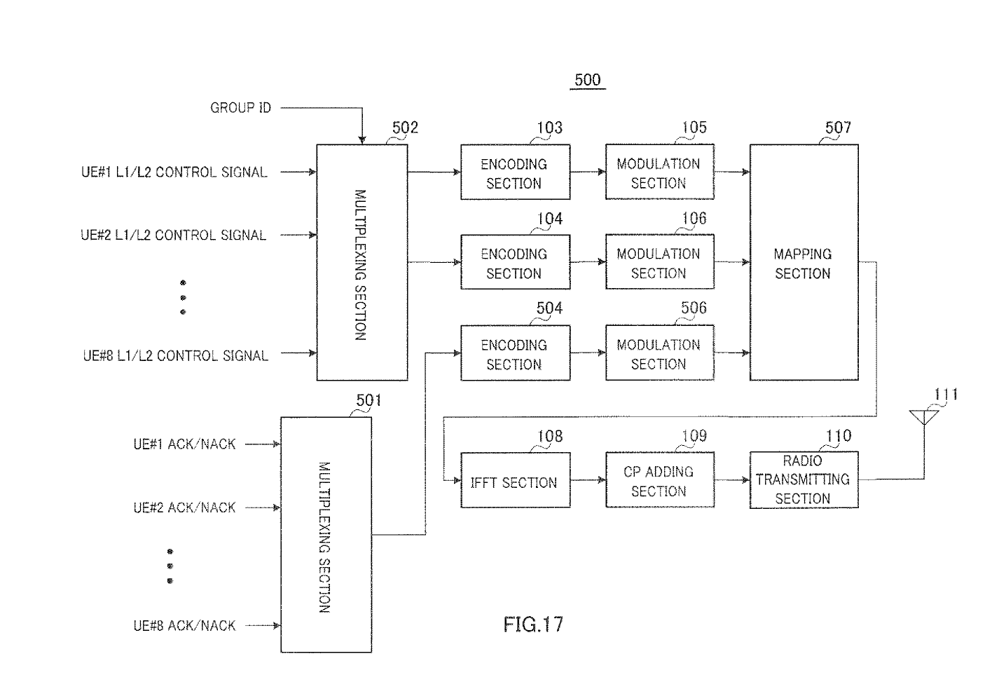

FIG. 17 is a block diagram showing a configuration of radio transmitting apparatus 500 according to Embodiment 3 of the present invention. Radio transmitting apparatus 500 has the same basic configuration as radio transmitting apparatus 300 shown in Embodiment 1 (see FIG. 3), and therefore the same components will be assigned the same reference numerals and explanations thereof will be omitted.

Radio transmitting apparatus 500 differs from radio transmitting apparatus 100 in that encoding section 504 and modulation section 506 are further provided. Multiplexing section 501, multiplexing section 502 and mapping section 507 of radio transmitting apparatus 500 execute processing partially different from the processing in multiplexing section 101, multiplexing section 102, and mapping section 107 of radio transmitting apparatus 100 and are therefore assigned reference numerals to show the differences.

Multiplexing section 501 is different from multiplexing section 101 of radio transmitting apparatus 100 only in that an ACK/NACK multiplexed signal that is generated is outputted to encoding section 504, not to multiplexing section 502.

Multiplexing section 502 is different from multiplexing section 102 in that a control information multiplexed signal is generated using only the group ID and L1/L2 control signals for a plurality of UE's, without including an ACK/NACK multiplexed signal, in both cases of initial transmission signaling and retransmission signaling.

Encoding section 504 performs error correcting encoding such as a convolutional encoding, Reed Muller encoding, and turbo encoding to the ACK/NACK multiplexed signal received as input from multiplexing section 501, and outputs the error correcting encoded signal obtained to modulation section 506. A configuration without performing error correcting encoding is also possible.

Modulation section 506 performs modulation processing such as PSK modulation or QAM modulation to the error correcting encoded signal received as input from encoding section 504 and outputs the modulated signal obtained to mapping section 507.

Mapping section 507 maps the modulated signal received as input from modulation sections 105 and 106 to their respective PDCCH's in the same TTI and also maps the ACK/NACK multiplexed signal received as input from modulation section 506 to a different PDCCH from the PDCCH's to which the modulated signal received as input from modulation sections 105 and 106 are mapped.

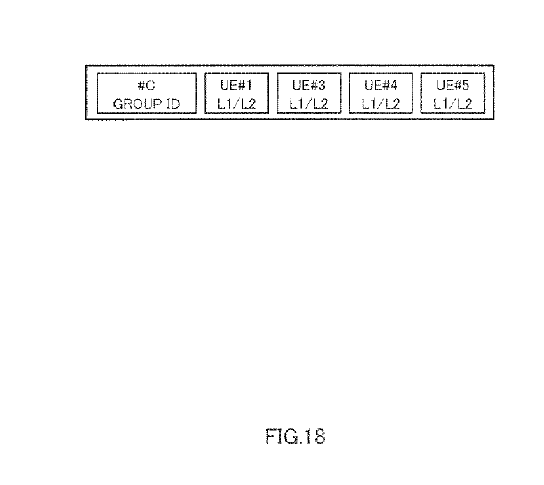

FIG. 18 shows a control information multiplexed signal that is obtained in multiplexing section 502 upon retransmission signaling. As shown in FIG. 18, upon retransmission signaling, multiplexing section 502 generates a control information multiplexed signal using only the group ID and L1/L2 control signals for a plurality of UE's, without including an ACK/NACK multiplexed signal. Since multiplexing section 502 does not multiplex an ACK/NACK multiplexed signal, multiplexing section 502 can further multiplex an L1/L2 control signal for one more retransmitting UE compared to multiplexing section 102 of radio transmitting apparatus 100. That is, as is clear from a comparison between FIG. 5 and FIG. 18, radio transmitting apparatus 100 according to Embodiment 1 can perform signaling on three retransmitting UE's, UE #1, UE #4 and UE #5, whereas radio transmitting apparatus 500 according to the present embodiment can perform signaling for four retransmitting UE's, UE #1, UE #3, UE #4 and UE #5.

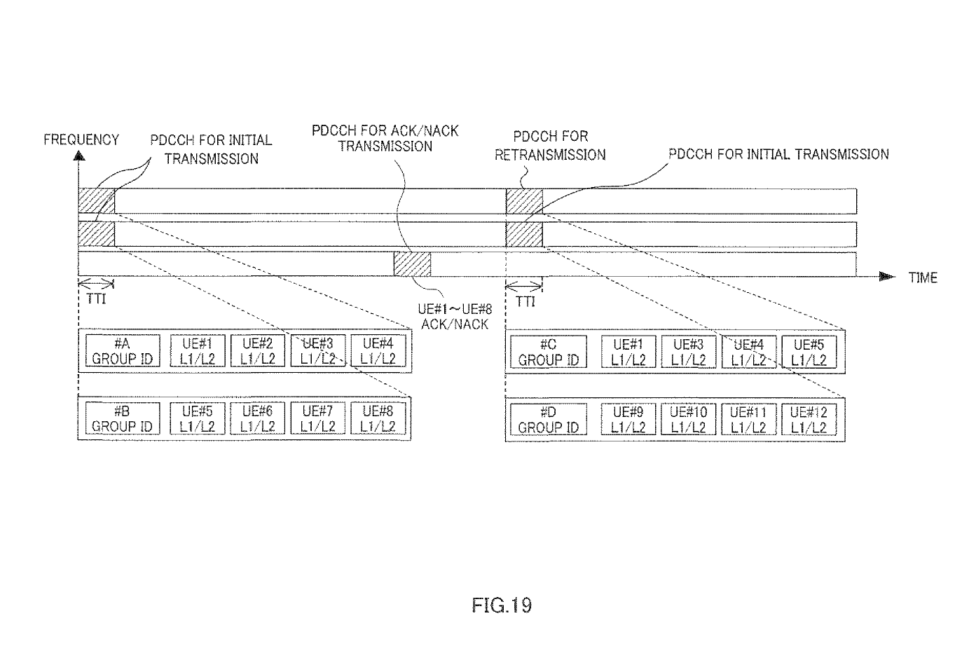

FIG. 19 shows a result of mapping the control information multiplexed signal that is obtained in multiplexing section 502 to a PDCCH by mapping section 507.

As shown in FIG. 19, in retransmission signaling, mapping section 507 maps the ACK/NACK multiplexed signal generated in multiplexing section 501 to a different PDCCH from the PDCCH to which the control information multiplexed signal generated in multiplexing section 502 is mapped. As shown in FIG. 19, the PDCCH to which the ACK/NACK multiplexed signal generated in multiplexing section 501 is mapped may be different from the PDCCH to which the control information multiplexed signal generated in multiplexing section 502 is mapped in terms of frequency.

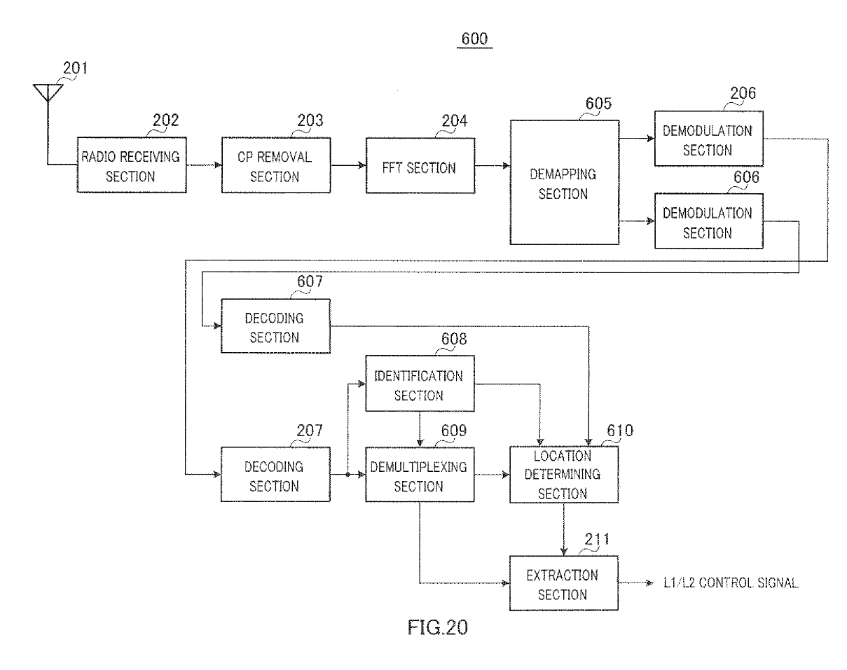

FIG. 20 is a block diagram showing a configuration of radio receiving apparatus 600 according to the present embodiment.

Radio receiving apparatus 600 has the same basic configuration as radio receiving apparatus 200 shown in Embodiment 1 (see FIG. 8), and therefore the same components will be assigned the same reference numerals and explanations thereof will be omitted.

Radio receiving apparatus 600 is different from radio receiving apparatus 200 in that demodulation section 606 and decoding section 607 are further provided. Demapping section 605, identification section 608, demultiplexing section 609 and location determining section 610 of radio receiving apparatus 600 execute processing partially different from that of demapping section 205, identification section 208, demultiplexing section 209 and location determining section 210 of radio transmitting apparatus 200, and are therefore assigned different reference numerals to show the differences.

Demapping section 605 separates a frequency domain signal received as input from FFT section 204 on a per PDCCH basis, outputs the PDCCH signal for the initial transmission and PDCCH signal for a retransmission amongst the PDCCH signals obtained, to demodulation section 206 and outputs a PDCCH signal for ACK/NACK transmission to demodulation section 606.

Demodulation section 606 performs demodulation processing on the ACK/NACK multiplexed signal received as input from demapping section 605 and outputs the demodulated signal obtained to decoding section 607.

Decoding section 607 performs error correction such as convolutional decoding, Reed Muller decoding and turbo decoding, on the demodulated signal received as input from demodulation section 606 and outputs the decoded signal obtained to location determining section 610.

Identification section 608 identifies whether or not the group ID of the decoded signal received as input from decoding section 207 is the group ID of the group to which the subject UE belongs, identifies, when the group ID is the group ID of the group to which the subject UE belongs, whether the decoded signal is signaling for the initial transmission or signaling for a retransmission, and outputs the identification result to location determining section 610.

Demultiplexing section 609 demultiplexes the group ID from the decoded signal received as input from decoding section 207, and outputs the decoded signal received as input from decoding section 207 to location determining section 610.

When the identification result received as input from identification section 608 indicates that the decoded signal is signaling for the initial transmission, location determining section 610 does not receive an ACK/NACK multiplexed signal from decoding section 607, and outputs the predetermined location where the L1/L2 control signal for the subject UE is arranged, to extraction section 211. Furthermore, when the identification result received as input from identification section 608 indicates that the decoded signal is signaling for a retransmission, location determining section 610 determines the location where the L1/L2 control signal for the subject UE is arranged, amongst the L1/L2 control signals for a plurality of UE's, based on the values of the bits in the ACK/NACK multiplexed signal received as input from decoding section 607, and outputs the location determination result obtained, to extraction section 211.

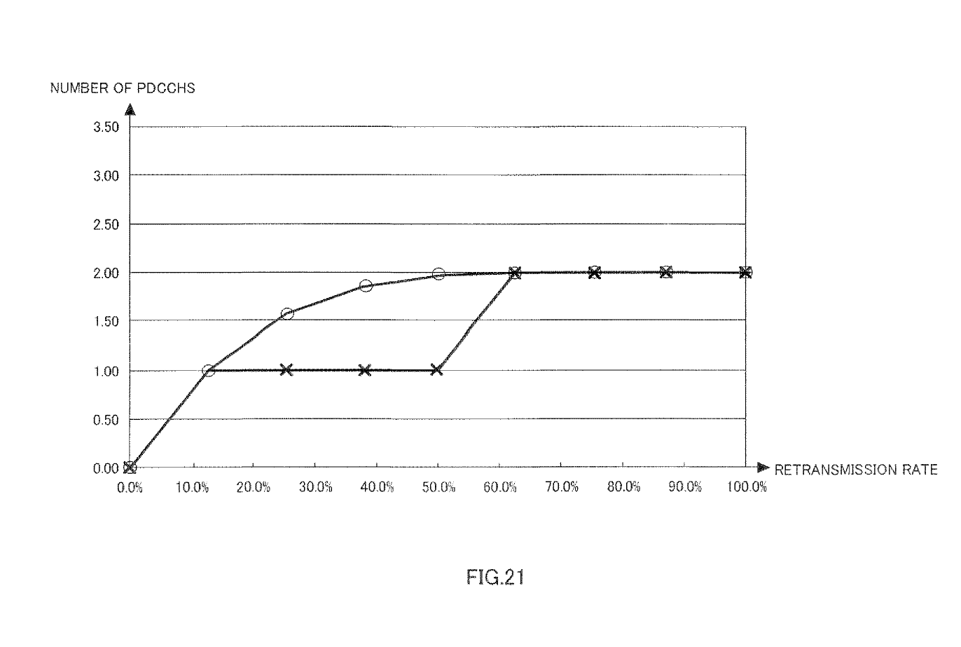

FIG. 21 shows an average value of the number of PDCCH's to be required depending on the rate of retransmissions as a theoretical calculation result of the signaling method according to the present embodiment.

For comparison, FIG. 21 also shows an average value of the number of PDCCH's to be required depending on the rate of retransmissions as a theoretical calculation result of the signaling method according to Non-Patent Document 1 at the same time. FIG. 21 shows the average value of the number of PDCCH's according to the present embodiment using the graph shown by the symbol “×” and shows an average value of the number of PDCCH's according to Non-Patent Document 1 using the graph shown by the symbol “∘.” Here, the “retransmission rate” refers to the probability that a retransmission is required due to a reception error when a transmission signal is transmitted.

As shown in FIG. 21, an average value of the number of PDCCH's according to the present embodiment is always equal to or less than the average value of the number of PDCCH's according to Non-Patent Document 1. Furthermore, as is clear from a comparison between FIG. 9, FIG. 16 and FIG. 21, the average value of the number of PDCCH's according to the present embodiment is equal to or less than the average value of the number of PDCCH's according to Embodiment 1 or Embodiment 2.

As described above, according to the present embodiment, the radio transmitting apparatus transmits an ACK/NACK multiplexed signal through a different PDCCH from the PDCCH's for L1/L2 control signals for retransmitting UE's in retransmission signaling, and thereby performing signaling for more retransmitting UE's using PDCCH's for transmitting L1/L2 control signals for the retransmitting UE's and furthermore improving the number of users for which control signals can be transmitted per unit time.

Embodiments of the present invention have been explained so far.

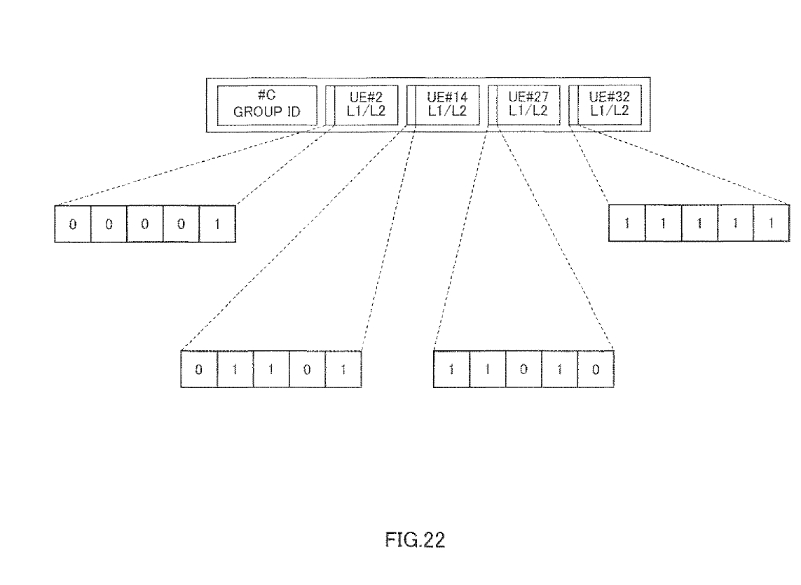

A case has been explained in the above embodiments as an example where each retransmitting UE is identified using an ACK/NACK multiplexed signal of retransmitting UE's. However, the present invention is not limited to this, and as shown in FIG. 22, the ID of each retransmitting UE may be added before an L1/L2 control signal for each retransmitting UE. In FIG. 22, the ID's “#2,” “#14,” “#27” and “#32” of the retransmitting UE's are given in the form of “00001,” “01101,” “11010” and “11111.” Thus, when the number of retransmitting UE's is equal to or greater than a predetermined threshold, signaling overhead can be reduced. For example, when four UE's are included in one group and ACK/NACK signals of 32 UE's included in these eight groups are multiplexed, it requires 32 bits to multiplex ACK/NACK signal on a per retransmission group basis as shown with the present embodiment. On the other hand, when ACK/NACK signals for 32 UE's of eight groups are collectively multiplexed, 32 UE's can be represented by 5-bit ID's. Therefore, as shown in FIG. 10, (5 bits/1 UE)×(4 UE's)=20 bits are necessary, so that 12 signaling bits can be reduced.

Furthermore, radio transmitting apparatus and radio communication method according to the present invention are not limited to the above embodiments, but can be implemented modified in various ways. For example, the embodiments can be implemented in combination with each other as appropriate. When Embodiment 2 and Embodiment 3 of the present invention are combined, “5” can be used as the predetermined threshold.

Furthermore, for the error detection processing by the encoding section according to the present invention, CRC-mask, which is an exclusive OR of a CRC code and ID, may be used.

Furthermore, UE's to be grouped in retransmission signaling according to the present invention may belong to a plurality of groups transmitted at different transmission timings (sub frames) in initial transmission signaling.

Furthermore, the ACK/NACK signal according to the present invention may also be referred to as “HICH (Hybrid ARQ Indicator channel).”

Furthermore, the control information multiplexed signal and ACK/NACK multiplexed signal used in the explanations of the above embodiments are comprised of sequence information arranged in time sequence, but multiplexing on radio resources need not always be time multiplexing, and may also be frequency multiplexing or code multiplexing.

Furthermore, a case has been mainly explained in the above embodiments where the number of groups is 2, the number of UE's belonging to one group is 4 and the total number of UE's is 8, but it goes without saying that the present invention is not limited to this. For example, 12 UE's belonging to three groups for the initial transmission may be grouped as one group at the time of retransmission and their control information may be transmitted. Furthermore, for example, assuming the number of UE's belonging to one group is 5, ten UE's belonging to two groups may be grouped as one group and their control information may be reported.

In the above embodiments, NACK=“1” and ACK=“0” are defined, but the present invention is not limited to this and NACK=“0” and ACK=“1” may also be defined.

Furthermore, an OFDM transmitting/receiving apparatus has been used as an example in the explanations of the above embodiments, but the present invention is not limited to this.

Furthermore, the PDCCH in the above embodiments denotes a “control channel” but the control channel need not be limited to this. For example, the 3GPP standard includes an HS-SCCH, which is an associated channel of an HS-DSCH.

Furthermore, the group ID in the above embodiments may also be referred to as a “G-RNTI (Group-Radio Network Temporary ID).”

Further, a radio communication base station apparatus may be referred to as a “Node B” and a “UE” maybe referred to as a mobile station apparatus.

A case has here been described by way of example in which the present invention is configured as hardware, but it is also possible for the present invention to be implemented by software. For example, the same kind of functions as those of a radio transmission apparatus according to the present invention can be realized by writing an algorithm of a pilot generation method according to the present invention in a programming language, storing this program in memory, and having it executed by an information processing means.

The function blocks used in the descriptions of the above embodiments are typically implemented as LSI's, which are integrated circuits. These may be implemented individually as single chips, or a single chip may incorporate some or all of them.

Here, the term LSI has been used, but the terms IC, system LSI, super LSI, ultra LSI, and so forth may also be used according to differences in the degree of integration.

The method of implementing integrated circuitry is not limited to LSI, and implementation by means of dedicated circuitry or a general-purpose processor may also be used. An FPGA (Field Programmable Gate Array) for which programming is possible after LSI fabrication, or a reconfigurable processor allowing reconfiguration of circuit cell connections and settings within an LSI, may also be used.

In the event of the introduction of an integrated circuit implementation technology whereby LSI is rearranged by a different technology as an advance in, or derivation from, semiconductor technology, integration of the function blocks may of course be performed using that technology. The application of biotechnology or the like is also a possibility.

The disclosure of Japanese Patent Application No. 2007-071260, filed on Mar. 19, 2007, including the specification, drawings and abstract, is incorporated herein by reference in its entirety.

### INDUSTRIAL APPLICABILITY

The radio communication base station apparatus according to the present invention is applicable to a technique of a mobile communication system that carries out group signaling whereby control signals for a plurality of UE's are grouped as one group and reported to the UE's.

1. A radio communication base station apparatus comprising:
a first multiplexing section that multiplexes an acknowledgment signal or negative acknowledgment signal for each of a plurality of terminals belonging to a plurality of groups for an initial transmission to generate an acknowledgment/negative acknowledgment multiplexed signal;
a second multiplexing section that multiplexes a group identity of one retransmission group associated with the plurality of groups and control information for some retransmitting terminals amongst the plurality of terminals, to generate a control information multiplexed signal; and
a transmitting section that transmits the acknowledgment/negative acknowledgment multiplexed signal and the control information multiplexed signal.

2. The radio communication base station apparatus according to claim 1, wherein:
the second multiplexing section further multiplexes the acknowledgment/negative acknowledgment multiplexed signal and the control information multiplexed signal; and
the transmitting section transmits the acknowledgment/negative acknowledgment multiplexed signal and the control information multiplexed signal in a same transmission time interval.

3. The radio communication base station apparatus according to claim 1, wherein the transmitting section transmits the acknowledgment/negative acknowledgment multiplexed signal and the control information multiplexed signal through different control channels.

4. The radio communication base station apparatus according to claim 1, wherein the second multiplexing section multiplexes group identities of the retransmission group comprised of a common part of the plurality of group identities of the plurality of groups.

5. The radio communication base station apparatus according to claim 1, further comprising a determining section that determines whether or not the number of retransmitting terminals is smaller than a predetermined threshold, wherein:
the second multiplexing section multiplexes, when the determining section determines that the number of retransmitting terminals is smaller than a predetermined threshold, a group identity of one retransmission group associated with the plurality of groups and control information for some retransmitting terminals amongst the plurality of terminals, to generate a control information multiplexed signal.

6. A radio communication method comprising the steps of:
multiplexing an acknowledgment signal or negative acknowledgment signal for each of a plurality of terminals belonging to a plurality of groups for the initial transmission to generate an acknowledgment/negative acknowledgment multiplexed signal;
multiplexing a group identity of one retransmission group associated with the plurality of groups and control information for some retransmitting terminals amongst the plurality of terminals to generate a control information multiplexed signal; and
transmitting the acknowledgment/negative acknowledgment multiplexed signal and the control information multiplexed signal.
